(19) United States
(12) Patent Application Publication
(10) Pub. No.: US 2024/0408941 A1
(43) Pub. Date: Dec. 12, 2024

(54) WINDOW REGULATOR MODULE

(71) Applicant: Johnan Manufacturing Inc., Ueda-shi (JP)

(72) Inventors: Hiroki SHIMIZU, Ueda-shi (JP); Manabu SHIMOMURA, Ueda-shi (JP); Wataru MURATA, Ueda-shi (JP)

(21) Appl. No.: 18/677,178

(22) Filed: May 29, 2024

(30) Foreign Application Priority Data
Jun. 9, 2023 (JP) 2023-095742

(51) Int. Cl. B60J 1/08; E05F 15/689

(52) U.S. Cl. CPC B60J 1/08; E05F 15/6907; E05Y 2201/668

(57) ABSTRACT

A window regulator module installed on a door panel of a vehicle door, the window regulator module including a window regulator to raise and lower a window glass of the vehicle door, and a module panel to which the window regulator is fixed. The module panel is foldable.

### CROSS-REFERENCE TO RELATED APPLICATIONS

The present patent application claims the priority of Japanese patent application No. 2023/095742 filed on Jun. 9, 2023, and the entire contents of Japanese patent application No. 2023/095742 are hereby incorporated by reference.

### TECHNICAL FIELD

The present invention relates to a window regulator module.

### BACKGROUND ART

A window regulator module is known which is configured such that plural functional components including a window regulator are attached to and integrated with a module panel that closes an opening of a door panel (see Patent Literature 1). In the window regulator module, the module panel and the plural functional components including the window regulator are integrated, which allows the module panel and the plural functional components including the window regulator to be attached as a single unit to the door panel.

### CITATION LIST

### Patent Literatures

Patent Literature 1: JP 2003/104052 A

### SUMMARY OF INVENTION

However, in recent years, the module panel has tended to become larger. Therefore, the problem of the known window regulator module arises that the size of the entire window regulator module increases with this increase in size of the module panel, resulting in that handling properties of the window regulator module during transportation, etc. become poor.

It is an object of the invention to provide a window regulator module that can have improved handling properties during transportation, etc.

According to an aspect of the invention, provided is a window regulator module installed on a door panel of a vehicle door, the window regulator module comprising:
a window regulator to raise and lower a window glass of the vehicle door; and
a module panel to which the window regulator is fixed,
wherein the module panel is foldable.

### ADVANTAGEOUS EFFECTS OF INVENTION

According to an embodiment of the invention, a window regulator module can be provided which has improved handling properties during transportation, etc.

### BRIEF DESCRIPTION OF DRAWINGS

FIG. 1 is a general schematic diagram illustrating a window regulator module in an embodiment of the present invention and a vehicle door in which the window regulator is installed.

FIG. 2A is a front view showing the window regulator module.

FIG. 2B is a plan view thereof.

FIG. 3A is a front view showing the window regulator module during transportation.

FIG. 3B is a plan view thereof.

FIG. 4A is a front view showing a module panel.

FIG. 4B is a plan view showing the module panel.

FIG. 4C is an enlarged plan view showing main parts around a right hinge portion and a left hinge portion in FIG. 4B.

### DESCRIPTION OF EMBODIMENTS

A window regulator module in an embodiment of the invention will be described below in reference to the appended drawings. This window regulator module is a module installed in a vehicle door of a vehicle (e.g., an automobile) and is a modularized (integrated) product in which plural functional components including a window regulator are assembled to a module panel. In particular, with this window regulator module, handling properties during transportation and installation, etc. are improved by configuring the module panel to be foldable. It should be noted that, left, right, front, back, up and down used in the following description are as defined in each drawing. In addition, in the present embodiment, an up-down direction of the vehicle coincides with an up-down direction of the window regulator module, a vehicle width direction coincides with a front-rear direction of the window regulator module, and a front-rear direction of the vehicle coincides with a left-right direction of the window regulator module.

### Configuration of a Vehicle Door

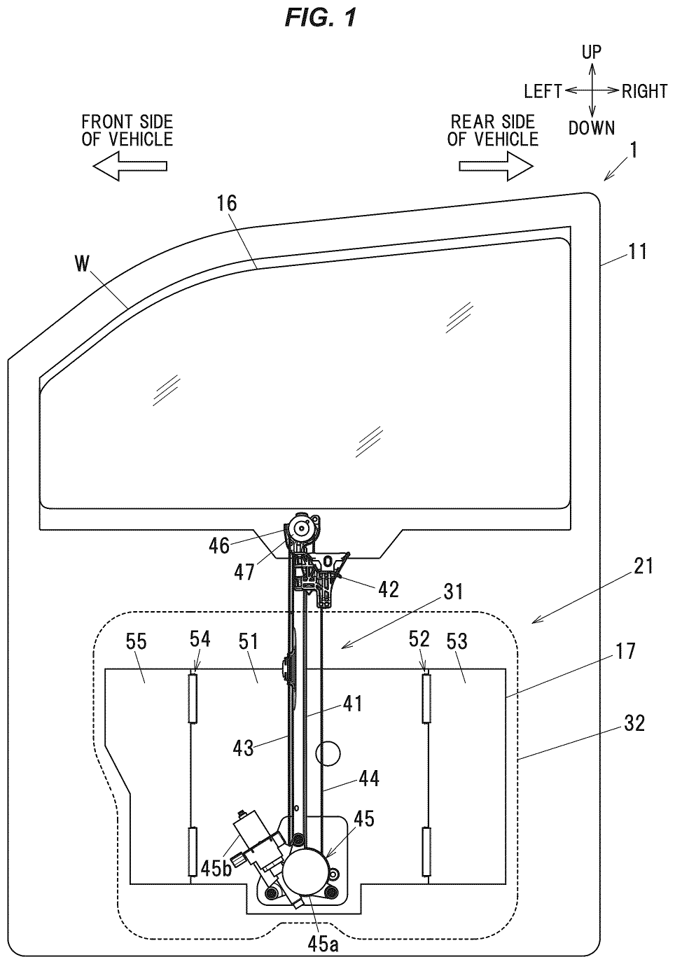

Here, before describing a window regulator module 21, a vehicle door 1 in which the window regulator module 21 is installed will be described. As shown in FIG. 1, the vehicle door 1 is composed of an inner panel 11 as a door panel on the interior side of the vehicle and an outer panel (not shown) on the exterior side of the vehicle, and a door internal space is formed between the inner panel 11 and the outer panel.

A window opening 16, which are opened and closed by a window glass W, is formed on upper portions of the inner panel 11 and the outer panel. Then, an introduction opening 17 to introduce the plural functional components including a window regulator 31 into the door internal space is formed on a lower portion of the inner panel 11. In the present embodiment, the window regulator module 21 is attached to the inner panel 11, and it is configured such that by attaching the window regulator module 21 to the inner panel 11, the plural functional components including the window regulator 31 are housed in the door internal space while closing the introduction opening 17 with the module panel 32.

### Configuration of the Window Regulator Module

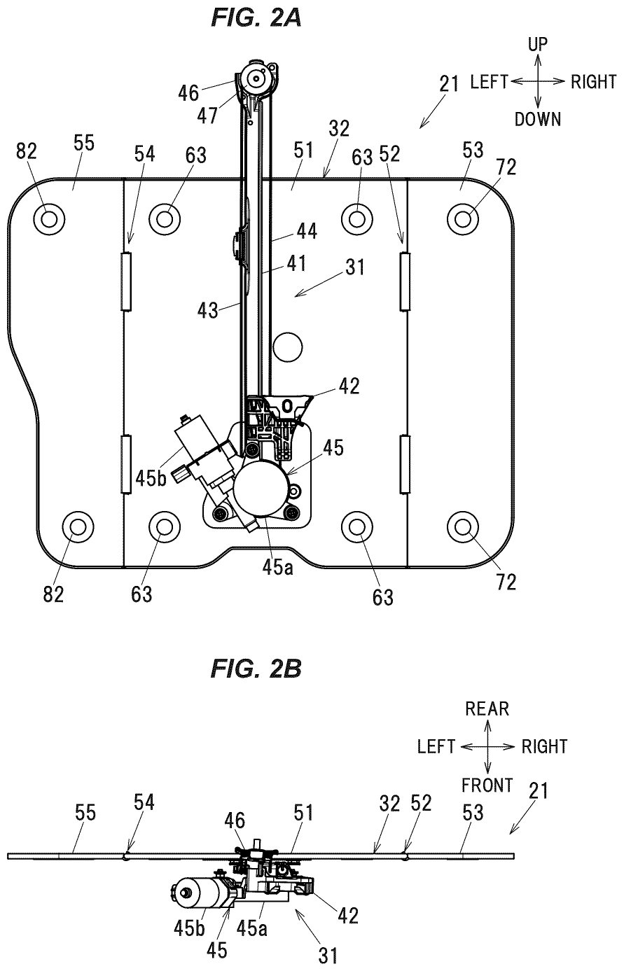

As shown in FIGS. 1 to 3, the window regulator module 21 includes the window regulator 31 that raises and lowers the window glass W of the vehicle door 1, and a module panel 32 to which the window regulator 31 is fixed. In addition to the window regulator 31, other functional components such as speaker are also assembled to the module panel 32, even though it is not shown in the drawings.

The window regulator 31 includes a guide rail 41 provided along an ascending/descending direction, a carrier plate 42 that supports the window glass W and is slidably attached to the guide rail 41, an ascending-side wire 43 and a descending-side wire 44 that pull the carrier plate 42, a drive unit 45 provided at a lower end portion of the guide rail 41 to drive the ascending-side wire 43 and the descending-side wire 44, and a pulley 47 fixed to an upper end portion of the guide rail 41 through a pulley bracket 46 to change the direction of the ascending-side wire 43. The drive unit 45 is driven to wind up one of the ascending-side wire 43 and the descending-side wire 44 while feeding out the other, thereby pulling the carrier plate 42 in the up-down direction and moving the carrier plate 42 in the up-down direction. The window glass W supported by the carrier plate 42 is thereby raised or lowered.

A housing 45a of the drive unit 45 fixed to the lower end portion of the guide rail 41 in the window regulator 31 is fixed to the module panel 32, and the window regulator 31 is thereby fixed to the module panel 32. In addition, the guide rail 41 extending upward from the housing 45a of the drive unit 45 extends beyond the upper end of the module panel 32 and protrudes upward from the module panel 32. Then, the pulley bracket 46 and the pulley 47 are fixed to the upper end portion of the guide rail 41 which is the top end protruding from the module panel 32, and the pulley bracket 46 and the pulley 47 fixed to the upper end portion of the guide rail 41 are fixed to the inner panel 11. That is, the window regulator 31 is fixed to the module panel 32 at the lower end and fixed to the inner panel 11 at the upper end.

Grease is applied to the guide rail 41 of the window regulator 31. Sliding noise or wear when the ascending-side wire 43 and the descending-side wire 44 come into contact with the guide rail 41 is suppressed by this grease.

### Configuration of the Module Panel

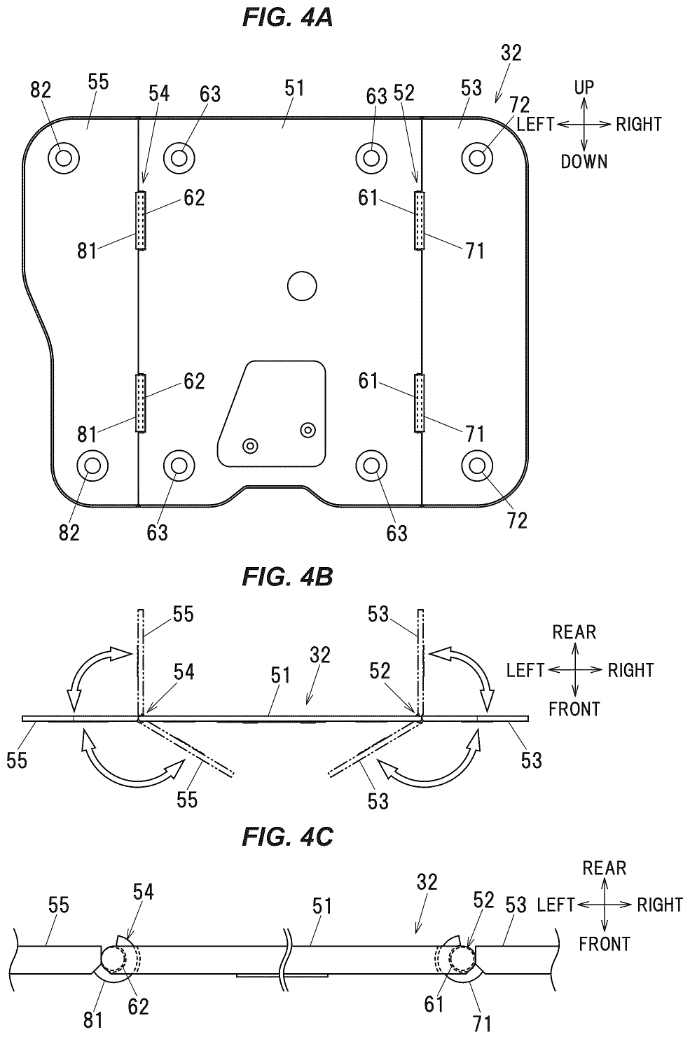

As shown in FIG. 4, the module panel 32 is a panel body that is fixed to the inner panel 11 with screws, is formed in a size that covers and closes the introduction opening 17, and is configured to be foldable. In particular, the module panel 32 is composed of a main plate portion 51 to which the window regulator 31 is fixed, a right folding plate portion 53 foldably connected to the right end of the main plate portion 51 through a right hinge portion 52, and a left folding plate portion 55 foldably connected to the left end of the main plate portion 51 through a left hinge portion 54. The main plate portion 51, the right folding plate portion 53, and the left folding plate portion 55 are each formed of a resin and are molded as separate parts. That is, the module panel 32 is composed of the main plate portion 51, the right folding plate portion 53 and the left folding plate portion 55 which are molded as separate parts and connected, and the module panel 32 is configured to be divided into three parts in the left-right direction. The right folding plate portion 53 is an example of the first folding plate portion, and the left folding plate portion 55 is an example of the second folding plate portion.

Two vertically-arranged right hinge shaft portions 61, 61, which are shaft portions constituting the right hinge portion 52, are formed at the right end of the main plate portion 51, and two vertically-arranged left hinge shaft portions 62, 62, which are shaft portions constituting the left hinge portion 54, are formed at the left end of the main plate portion 51. In addition, four fixing holes 63 to fix the main plate portion 51 to the inner panel 11 with screws are formed respectively at four corners of the main plate portion 51.

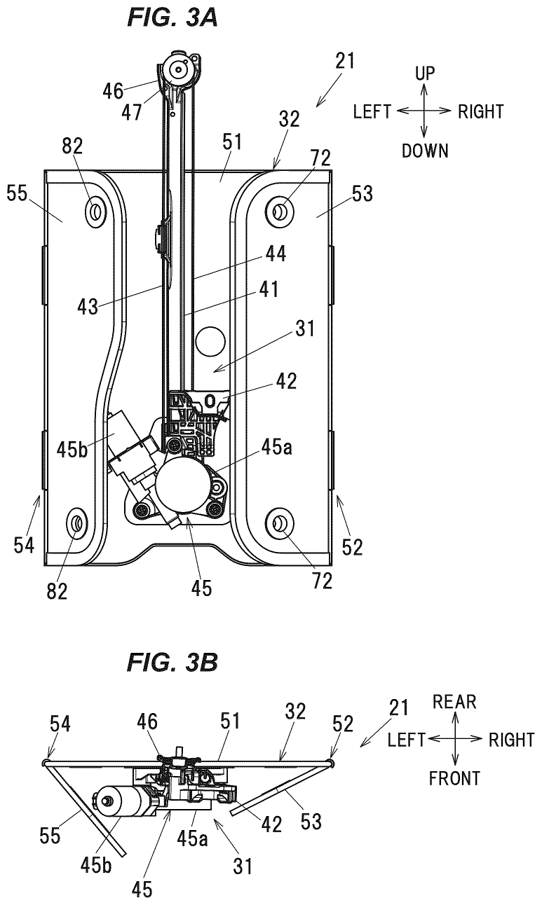

As shown in FIG. 4A, two vertically-arranged hinge cylinder portions 71, 71, which are cylinder portions constituting the right hinge portion 52, are formed at the left end of the right folding plate portion 53. In addition, two fixing holes 72, 72 to fix the right folding plate portion 53 to the inner panel 11 with screws are formed respectively at the upper and lower ends of the right folding plate portion 53. In addition, as shown in FIG. 3A, a width dimension in the left-right direction of the right folding plate portion 53 is such a size that the right folding plate portion 53 when folded with respect to the main plate portion 51 overlaps a portion of the window regulator 31 (in the present embodiment, the carrier plate 42 located at the lower limit position) when viewed from the front. That is, the main plate portion 51 and the right folding plate portion 53 are divided at a position allowing the right folding plate portion 53 to overlap a portion of the window regulator 31 when the right folding plate portion 53 is folded with respect to the main plate portion 51.

As shown in FIG. 4A, two vertically-arranged hinge cylinder portions 81, 81, which are cylinder portions constituting the left hinge portion 54, are formed at the right end of the left folding plate portion 55. In addition, two fixing holes 82, 82 to fix the left folding plate portion 55 to the inner panel 11 with screws are formed respectively at the upper and lower ends of the left folding plate portion 55. In addition, as shown in FIG. 3A, a width dimension in the left-right direction of the left folding plate portion 55 is such a size that the left folding plate portion 55 when folded with respect to the main plate portion 51 overlaps a portion of the window regulator 31 (in the present embodiment, a drive motor 45b of the drive unit 45) when viewed from the front. That is, the main plate portion 51 and the left folding plate portion 55 are divided at a position allowing the left folding plate portion 55 to overlap a portion of the window regulator 31 when the left folding plate portion 55 is folded with respect to the main plate portion 51.

As shown in FIG. 4C, the right hinge portion 52 is composed of the two right hinge shaft portions 61, 61 formed on the main plate portion 51, and the two hinge cylinder portions 71, 71 formed on the right folding plate portion 53. That is, the right hinge portion 52 is formed by respectively engaging the two right hinge shaft portions 61, 61 with the two hinge cylinder portions 71, 71. The right folding plate portion 53 is pivotably connected to the main plate portion 51 by the right hinge portion 52. As a result, the right folding plate portion 53 is connected to the main plate portion 51 so as to be foldable from the state parallel to the main plate portion 51 toward the side where the window regulator 31 is fixed (toward the front side) as shown in FIG. 4B, and overlaps a portion of the window regulator 31 when folded with respect to the main plate portion 51 as shown in FIG. 3A. In addition, the right folding plate portion 53 is connected to the main plate portion 51 so as to be movable (pivotable) from the state parallel to the main plate portion 51 toward the side opposite to the inner panel 11 (toward the rear side), as shown in FIG. 4B.

As shown in FIG. 4C, the left hinge portion 54 is composed of the two left hinge shaft portions 62, 62 formed on the main plate portion 51, and the two hinge cylinder portions 81, 81 formed on the left folding plate portion 55. That is, the left hinge portion 54 is formed by respectively engaging the two left hinge shaft portions 62, 62 with the two hinge cylinder portions 81, 81. The left folding plate portion 55 is pivotably connected to the main plate portion 51 by the left hinge portion 54. As a result, the left folding plate portion 55 is connected to the main plate portion 51 so as to be foldable from the state parallel to the main plate portion 51 toward the side where the window regulator 31 is fixed (toward the front side) as shown in FIG. 4B, and overlaps a portion of the window regulator 31 when folded with respect to the main plate portion 51 as shown in FIG. 3A. In addition, the left folding plate portion 55 is connected to the main plate portion 51 so as to be movable (pivotable) from the state parallel to the main plate portion 51 toward the side opposite to the inner panel 11 (toward the rear side), as shown in FIG. 4B.

In the present embodiment, at the time of transportation, the window regulator 31 is transported with the carrier plate 42 located at the lower limit position and the module panel 32 folded, as shown in FIGS. 3A and 3B. As shown in these drawings, when the module panel 32 is folded, the left and right folding plate portions 53 and 55 are collapsed so as to overlap portions of the window regulator 31 and the window regulator 31 is surrounded by the left and right folding plate portions 53 and 55. This prevents other window regulator modules 21 being transported together, worker's hands, or transport boxes, etc., from coming into contact with this window regulator 31. Since it is possible to prevent particularly the contact of other window regulator modules 21, worker's hands, or transport boxes, etc., with the guide rail 41 of the window regulator 31, it is possible to prevent the grease applied to the guide rail 41 from sticking to the other window regulator modules 21, the worker's hands, or the transport boxes, etc.

Next, an operation of installing the window regulator module 21 to the vehicle door 1 will be described. In the operation of installing the window regulator module 21, at first, the plural functional components including the window regulator 31 are introduced into the door internal space through the introduction opening 17. After that, the main plate portion 51 is aligned with the inner panel 11 in the state in which the right folding plate portion 53 and the left folding plate portion 55 are pivoted rearward relative to the main plate portion 51, and the main plate portion 51 is fixed to the inner panel 11 with screws through the four fixing holes 63 in the state in which main plate portion 51 is pressed against the inner panel 11 from the rear side. After fixing the main plate portion 51 to the inner panel 11 with screws, the right folding plate portion 53 is pivoted relative to the main plate portion 51, and the right folding plate portion 53 is fixed to the inner panel 11 with screws through the two fixing holes 72 in the state in which the right folding plate portion 53 is pressed against the inner panel 11. Furthermore, the left folding plate portion 55 is pivoted relative to the main plate portion 51, and the left folding plate portion 55 is fixed to the inner panel 11 with screws through the two fixing holes 82 in the state in which the left folding plate portion 55 is pressed against the inner panel 11. After fixing the main plate portion 51, the right folding plate portion 53 and the left folding plate portion 55 with screws, the pulley bracket 46 and the pulley 47 of the window regulator 31 are fixed to the inner panel 11. Then, the operation of installing the window regulator module 21 ends.

### Functions and Effects of the Embodiment

In the configuration of the embodiment described above, since the module panel 32 is configured to be foldable, the module panel 32 can be transformed to a compact shape by folding the module panel 32 when not in use, such as during transportation, thereby reducing the overall size of the window regulator module 21. This improves the handling properties during transportation, etc., and in particular, improves transportation efficiency of the window regulator module 21.

Furthermore, since the module panel 32 is configured to be foldable, the folding plate portions 53 and 55 can be used as supports when plural window regulator modules 21 are transported in a standing position (an upright position). Therefore, it is possible to prevent the window regulator module 21 in a standing position from falling over due to impact during transportation. This prevents the window regulator module 21 in a standing position from collapsing onto other window regulator modules 21 and causing damage during transportation.

In addition, since the folding plate portions 53 and 55 are configured to overlap portions of the window regulator 31 when the folding plate portions 53 and 55 are folded with respect to the main plate portion 51, it is possible to surround the window regulator 31 by the folding plate portions 53 and 55 when not in use, such as during transportation, and it is possible to prevent the contact of other window regulator modules 21, worker's hands, or transport boxes, etc., with the window regulator 31. Particularly, it is possible to prevent the grease applied to the guide rail 41 from sticking to the other window regulator modules 21, the worker's hands, or the transport boxes, etc. It is also possible to protect the window regulator 31.

In addition, since the folding plate portions 53 and 55 is configured to be movable (pivotable) relative to the main plate portion 51 toward the side opposite to the inner panel 11, the handling properties when installing the window regulator module 21 can be improved.

In addition, since the module panel 32 is divided into the main plate portion 51 and the folding plate portions 53 and 55 which are molded separately, there is no need to use a large molding machine, and the module panel 32 can be molded with a small molding machine. It is also possible to reduce molding time and molding costs.

In addition, since the module panel 32 is divided into the main plate portion 51 and the folding plate portions 53 and 55 which are molded separately, it is possible to change the size of the module panel 32 by replacing the folding plate portions 53 and 55 with those having a different width dimension without changing the main plate portion 51, hence, it is possible to provide window regulator modules 21 of various sizes and shapes.

### Other Embodiments

Although the embodiment of the invention has been described, the invention according to claims is not limited to the embodiment described above. Further, it should be noted that not all combinations of the features described in the embodiment are necessary to solve the problem of the invention. The invention can be appropriately modified and implemented without departing from the gist thereof.

For example, in the embodiment described above, the module panel 32 is divided into three parts which are the main plate portion 51, the right folding plate portion 53 and the left folding plate portion 55, and the module panel 32 is foldable. However, it is not limited thereto.

That is, the module panel 32 may be configured to be foldable into not less than four by dividing the module panel 32 into not less than four (e.g., five).

In addition, in the embodiment described above, it is configured to include the right folding plate portion 53 (the first folding plate portion) connected to one end in the left-right direction of the module panel 32 and the left folding plate portion 55 (the second folding plate portion) connected to the other end in the left-right direction of the module panel 32. However, it may be configured to include only one of the right folding plate portion 53 and the left folding plate portion 55.

In addition, in the embodiment described above, the module panel 32 is configured to be foldable at the left and right, having the folding plate portions 53 and 55 connected to the left and right ends of the main plate portion 51. However, the module panel 32 may be foldable at the top and bottom, having the folding plate portions 53 and 55 connected to the upper and lower ends of the main plate portion 51.

In addition, in the embodiment described above, the folding plate portions 53 and 55 are connected to the main plate portion 51 so as to be foldable toward the front side (toward the side where the window regulator 31 is fixed). However, the folding plate portions 53 and 55 may be connected to the main plate portion 51 so as to be foldable toward the rear side.

In addition, in the embodiment described above, the main plate portion 51 and the folding plate portions 53 and 55 are connected by the hinge portions 52, 54 which are composed of the hinge shaft portions 61, 62 integrally molded with the main body of the main plate portion 51 and the hinge cylinder portions 71, 81 integrally molded with the main bodies of the folding plate portions 53 and 55. However, the configuration is not limited thereto. That is, the main plate portion 51 and the folding plate portions 53 and 55 may be connected by the hinge portions 52, 54 that are formed as separate parts from the main plate portion 51 and the folding plate portions 53 and 55.

In addition, in the embodiment described above, the main plate portion 51 and the folding plate portions 53 and 55 are molded as separate parts. However, the main plate portion 51 and the folding plate portions 53 and 55 may be molded as a single part. In such a case, the hinge portions 52 and 54 are constituted by, e.g., thin-walled portions.

In addition, in the embodiment described above, the main plate portion 51 and the guide rail 41 are formed as separate parts. However, the main plate portion 51 and the guide rail 41 may be formed as a single part. In such a case, the main plate portion 51 and the guide rail 41 are formed of, e.g., a resin.

In addition, in the embodiment described above, the upper portion of the window regulator 31 protrudes upward from the module panel 32 and is fixed to the inner panel 11, and the lower portion of the window regulator 31 is fixed to the module panel 32. However, the configuration is not limited thereto as long as the window regulator 31 is fixed to the module panel 32. For example, the configuration may be such that the entire window regulator 31 is located on the module panel 32 and the upper and lower portions of the window regulator 31 are fixed to the module panel 32, or such that the lower portion of the window regulator 31 protrudes downward from the module panel 32 and is fixed to the inner panel 11, and the upper portion of the window regulator 31 is fixed to the module panel 32.

In addition, in the embodiment described above, the folding plate portions 53 and 55 when folded overlap portions of the window regulator 31. However, the configuration is not limited thereto. For example, the folding plate portions 53 and 55 when folded with respect to the main plate portion 51 may not overlap the window regulator 31, or the folding plate portions 53 and 55 when folded with respect to the main plate portion 51 may cover the entire window regulator 31. Furthermore, the folding plate portions 53 and 55 when folded with respect to the main plate portion 51 may cover part or all of the guide rail 41 to further prevent sticking of the grease applied to the guide rail 41.

In addition, in the embodiment described above, the invention is applied to the window regulator module 21 equipped with the wire driving-type and lower end drive-type window regulator 31 which is driven by the wires 43 and 44 and in which the drive unit 45 is located at the lower end of the guide rail 41. However, the window regulator 31 mounted on the window regulator module 21 is not limited thereto. For example, the invention may be applied to the window regulator module 21 equipped with another wire driving-type window regulator such as delta-type, banjo-type, self-propelled type or double-rail type, or the invention may be applied to the window regulator module 21 equipped with a window regulator other than the wire driving-type window regulator, such as arm driving-type window regulator.

In addition, in the embodiment described above, the window regulator module 21 installed in the left front door (i.e., the left front side door) has been described as an example.

However, it is not limited thereto. That is, the invention may be applied to the window regulator module 21 installed in the right side door, or the invention may be applied to the window regulator module 21 installed in the rear side door.

### Summary of the Embodiments

Technical ideas understood from the embodiments will be described below citing the reference signs, etc., used for the embodiments. However, each reference sign, etc., described below is not intended to limit the constituent elements in the claims to the members, etc., specifically described in the embodiments.
(a) A window regulator module (21) installed on a door panel (11) of a vehicle door (1), the window regulator module (21) comprising: a window regulator (31) to raise and lower a window glass (W) of the vehicle door (1); and a module panel (32) to which the window regulator (31) is fixed, wherein the module panel (32) is foldable.
(b) The window regulator module (21) defined in (a), wherein the module panel (32) comprises a main plate portion (51) to which the window regulator (31) is fixed, and folding plate portions (53, 55) foldably connected to the main plate portion (51).
(c) The window regulator module (21) defined in (b), wherein the folding plate portions (53, 55) is connected to the main plate portion (51) so as to be foldable toward a side where the window regulator (31) is fixed, and, when folded with respect to the main plate portion (51), overlaps at least a portion of the window regulator (31).
(d) The window regulator module (21) defined in (b) or (c), wherein the first one (53) of the folding plate portions is connected to one end of the main plate portion (51), and the second one (55) of the folding plate portions is connected to the other end of the main plate portion (51).
(e) The window regulator module (21) defined in any one of (b) to (d), wherein the folding plate portion (53, 55) is connected to the main plate portion (51) so as to be movable toward an opposite side to the door panel (11).
(f) The window regulator module (21) defined in any one of (b) to (e), wherein the main plate portion (51) and the folding plate portion (53, 55) are molded as separate parts.

### REFERENCE SIGNS LIST

1 VEHICLE DOOR
11 INNER PANEL
21 WINDOW REGULATOR MODULE
31 WINDOW REGULATOR
32 MODULE PANEL
51 MAIN PLATE PORTION
53 RIGHT FOLDING PLATE PORTION
55 LEFT FOLDING PLATE PORTION

1. A window regulator module installed on a door panel of a vehicle door, the window regulator module comprising:
a window regulator to raise and lower a window glass of the vehicle door; and
a module panel to which the window regulator is fixed,
wherein the module panel is foldable.

2. The window regulator module according to claim 1, wherein the module panel comprises a main plate portion to which the window regulator is fixed, and a folding plate portion foldably connected to the main plate portion.

3. The window regulator module according to claim 2, wherein the folding plate portion is connected to the main plate portion so as to be foldable toward a side where the window regulator is fixed, and, when folded with respect to the main plate portion, overlaps at least a portion of the window regulator.

4. The window regulator module according to claim 3, wherein the module panel comprises two of the folding plate portion,
wherein a first one of the two folding plate portions is connected to one end of the main plate portion, and
wherein a second one of the two folding plate portions is connected to an other end of the main plate portion.

5. The window regulator module according to claim 2, wherein the folding plate portion is connected to the main plate portion so as to be movable toward an opposite side to the door panel.

6. The window regulator module according to claim 2, wherein the main plate portion and the folding plate portion are molded as separate parts.
